(19) United States
(12) Patent Application Publication
(10) Pub. No.: US 2016/0139344 A1
(43) Pub. Date: May 19, 2016

(54) FIBER OPTIC CONNECTOR WITH FRONT-LOADING FERRULE HOLDER

(71) Applicant: CORNING OPTICAL COMMUNICATIONS LLC, Hickory, NC (US)

(72) Inventors: Cesar Alejandro de los Santos Campos, Reynosa (MX); Benjamin Cuauhtemoc Linares Rios, Reynosa (MX); Louis Edward Parkman, III, Richland Hills, TX (US); Thomas Theuerkorn, Hickory, NC (US); Chanh Cuong Vo, Keller, TX (US)

(21) Appl. No.: 15/005,425

(22) Filed: Jan. 25, 2016

Related U.S. Application Data
(63) Continuation of application No. PCT/US13/52976, filed on Jul. 31, 2013.

(51) Int. Cl. G02B 6/38

(52) U.S. Cl. CPC G02B 6/3871; G02B 6/3851

(57) ABSTRACT

A fiber optic connector comprises a ferrule extending along a longitudinal axis, a ferrule holder having a body in which the ferrule is received and at least one arm extending from the body, and a housing having a passage in which the ferrule holder is received. The passage is shaped to accommodate insertion of the ferrule holder from a front end of the housing, and the housing further includes at least one retention member that cooperates with the at least one arm to retain the ferrule holder in the housing. The at least one arm is configured to flex toward and away from an outer surface of the body to provide a snap-fit coupling between the ferrule holder and housing.

### PRIORITY APPLICATION

This application is a continuation of International Application No. PCT/US13/52976, filed on Jul. 31, 2013, the content of which is relied upon and incorporated herein by reference in its entirety.

### BACKGROUND

The disclosure relates generally to fiber optic connectors and more particularly to a fiber optic connector that includes a front-loading ferrule holder. Related components, cable assemblies, and methods are also disclosed.

In a system that uses fiber optic cables, there are typically many locations where the cables connect to equipment or other fiber optic cables. Fiber optic connectors are provided on the ends of the cables to allow the transfer of light at these connection points. The process of installing a fiber optic connector on an optical fiber of a cable is sometimes referred to as “connectorization,” and this process may be done in the field (e.g., with “field-installable” connectors) or in a factory (e.g., during the manufacturing of the fiber optic cables to provide “pre-terminated” cable assemblies).

FIG. 1 illustrates an example of a conventional SC-type fiber optic connector 10. In general, the fiber optic connector 10 includes a ferrule 12 having a mating end 14 and an insertion end (not shown), a ferrule holder 16 having opposed first and second end portions 18, 20, and an inner housing 22. The insertion end of the ferrule 12 is received in the first end portion 18 of the ferrule holder 16 while the mating end 14 remains outside the ferrule holder 16. To assemble the fiber optic connector 10, the ferrule holder 16 is inserted into a rear opening 24 of the inner housing 22 such that the mating end 14 of the ferrule 12 is positioned proximate a front opening (not shown) of the inner housing 22. A spring 26 is then disposed around the second end portion 20 of the ferrule holder 16, after which a crimp body 28 is inserted into the rear opening 24 of the inner housing 22 and over the second end portion 20 of the ferrule holder 16 and the spring 26. The crimp body 28 has a plurality of radial teeth 30 that align with grooves 32 within the rear opening 24 of the inner housing 22 and a snap fit flange 34 that securely mates with a complementary snap fit feature (not shown) within the inner housing 22. An unterminated fiber optic cable 36 can then be passed through the crimp body 28 to be mated with the ferrule holder 16 for final assembly of the connectorized optical cable.

These and other methods of assembling fiber optic cable connectors include a number of mechanical steps and typically may include manual labor. The influence of manual labor in the assembly process provides cost, affects consistency, and can decrease throughput in processing fiber optic connector terminations. Automated fiber optic connector termination processes for fiber optic cable preparations have been employed to reduce manual labor influence, but at significant capital costs. Even so, these automated fiber optic connector termination processes may not be flexible with respect to terminating varieties of fiber optic connectors or fiber optic cable types. Further, with these fiber optic connector termination processes, if one fiber optic connector termination fails, it must be reworked or the entire fiber optic cable must scrapped. In either case, the fiber optic cable assembly can be delayed, thereby disrupting fiber optic cable assembly throughput and increasing scrapped fiber optic cables, increasing costs as a result.

### SUMMARY

One embodiment of the disclosure relates to a fiber optic connector including a ferrule extending along a longitudinal axis, a ferrule holder having a body in which the ferrule is received, and a housing having a passage in which the ferrule holder is received. The ferrule holder further includes at least one arm extending from the body of the ferrule holder and configured to flex toward and away from an outer surface of the body. The passage of the housing is shaped to accommodate insertion of the ferrule holder from a front end of the housing, and the ferrule holder is retained in the passage by a snap-fit coupling between the at least one arm and the housing.

An additional embodiment of the disclosure relates to a fiber optic connector including a ferrule extending along a longitudinal axis, a ferrule holder having a body in which the ferrule is received, and a housing having a passage in which the ferrule holder is received. The ferrule holder further includes at least one arm extending from the body of the ferrule holder and configured to flex toward and away from an outer surface of the body. The passage of the housing is shaped to accommodate insertion of the ferrule holder from a front end of the housing. The housing includes at least one retention member cooperating with the at least one arm to retain the ferrule holder in the housing.

Yet another embodiment of the disclosure relates to a fiber optic connector including a ferrule extending along a longitudinal axis, a ferrule holder having a body in which the ferrule is received, and a housing having a passage in which the ferrule holder is received. The ferrule holder further includes at least one arm extending from the body of the ferrule holder and configured to flex toward and away from an outer surface of the body. The passage of the housing is shaped to accommodate insertion of the ferrule holder from a front end of the housing. A constricting portion of the passage is sized to limit the at least one arm to a first radial position relative to the body, and a retention portion of the passage is sized to accommodate the at least one arm in a second radial position relative to the body. The second radial position is further from the longitudinal axis than the first radial position.

Methods of assembling a fiber optic connector are also disclosed. One method involves providing a ferrule holder having a body and at least one arm extending from the body. The at least one arm is configured to flex toward and away from at least a portion of the body. The method also involves providing a housing having a front end, a rear end, a passage extending between the front and rear ends, and at least one retention member. The ferrule holder is inserted into the passage from the front end of housing. The ferrule holder is then moved along the passage toward the rear end of the housing, and such movement results in contact between an inner wall of the housing and the at least one arm that causes the at least one arm to flex toward the body. After the at least one arm is moved to or past the at least one retention member, the ferrule holder is released. The at least one retention member then allows the arm to move away from the body and cooperates with the at least one arm to retain the ferrule holder in the housing.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is an exploded isometric view of a fiber optic connector having a rear-loading ferrule holder, as known in the art;

FIG. 2 is an exploded isometric view of one example of a fiber optic connector having a front-loading ferrule holder;

FIG. 3 is an isometric view showing the ferrule holder of FIG. 2 in isolation;

FIG. 4 is a cross-sectional side view of the fiber optic connector of FIG. 2 in an assembled configuration;

FIG. 4A is an enlarged view of the area circled in FIG. 4;

FIGS. 5A-5C are cross-sectional side views sequentially illustrating the ferrule holder of FIG. 2 being inserted into a housing of the fiber optic connector;

FIG. 6 is a cross-sectional side view of a fiber optic connector according to an alternative embodiment;

FIG. 7 is an exploded isometric view of a fiber optic connector according to yet another embodiment; and

FIG. 8 is a cross-sectional side view of the fiber optic connector of FIG. 7.

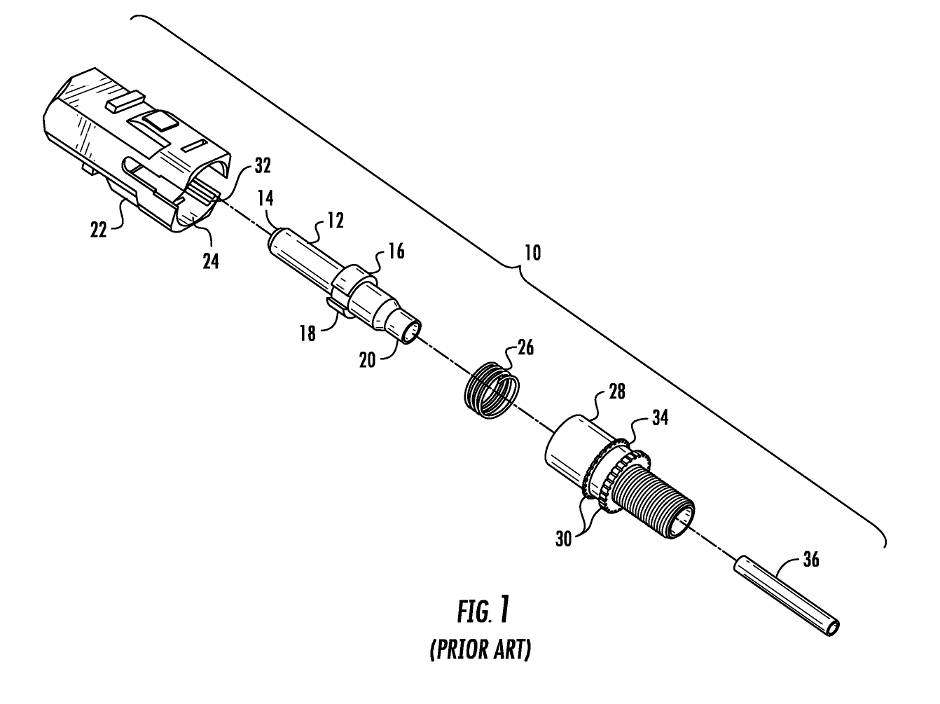

### DETAILED DESCRIPTION

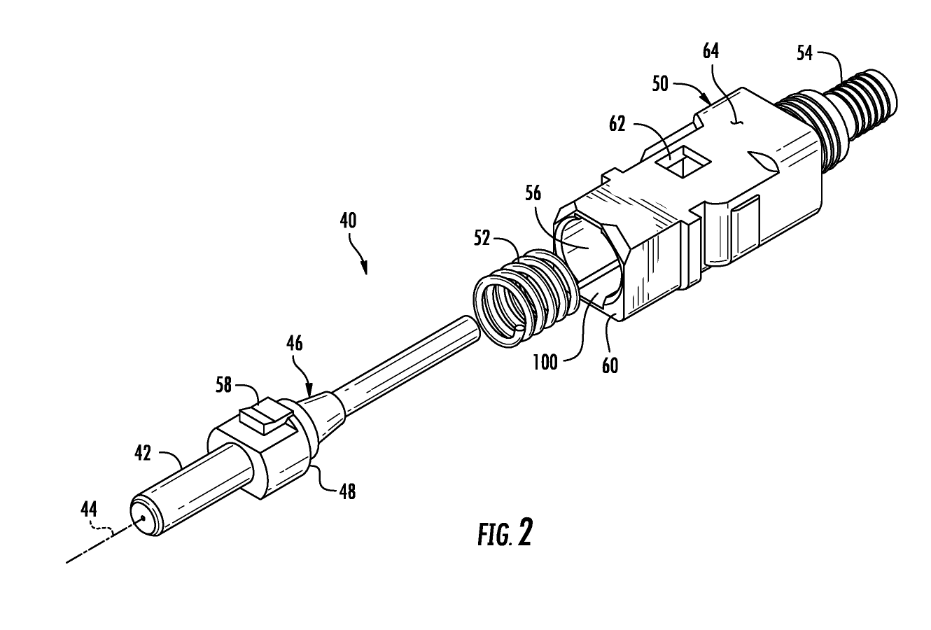

Various embodiments will be further clarified by the following examples. To this end, FIG. 2 illustrates one example of a fiber optic connector 40 (“connector”) for a cable assembly (the cable is not shown). Although the fiber optic connector 40 is shown in the form of a SC-type connector, the description below relates to details that may apply to other types of fiber optic connectors. This includes ST, LC, FC, and MU-style connectors with or without angled end faces, for example.

In general, the fiber optic connector 40 includes a ferrule 42 extending along a longitudinal axis 44, a ferrule holder 46 having a body 48 that receives the ferrule 42, and a housing 50 in which the ferrule holder 46 is disposed. A bias member, such as a spring 52, and a crimp body 54 may also be provided in some embodiments for reasons mentioned below. Additionally, in a manner not shown herein, the fiber optic connector 40 may further include an outer sheath (not shown) received over the housing 50 (effectively making the housing 50 an “inner housing”). It is therefore apparent that the term “fiber optic connector” is used herein in a generic sense, applying to sub-assemblies including only a ferrule, ferrule holder, and housing in some embodiments, and to more complete assemblies including a bias member, crimp body, and/or outer sheath in other embodiments.

Still referring to FIG. 2, the ferrule holder 46 is received in a passage 56 of the housing 50 and further includes at least one arm 58 extending from the body 48. First and second arms 58a, 58b (FIG. 4) are provided in the embodiment shown, although embodiments with a different number of arms are also possible. This includes embodiments with a single arm and embodiments where there are a plurality of arms (i.e., two or more arms 58) circumferentially distributed about the body 48. The arm(s) 58 are compliant in a direction generally transverse to the longitudinal axis 44. That is, the arm(s) 58 are configured to flex toward and away from at least a portion of the body 48.

The passage 56 of the housing 50 is shaped to accommodate insertion of the ferrule holder 48 from a front end 60 of the housing 50. In an assembled condition of the fiber optic connector 40, the arm(s) 58 cooperate with one or more retention members 62 on the housing 50 to retain the ferrule holder 46 in the passage 56. The retention members 62 may be, for example, openings formed between an outer surface 64 of the housing and the passage 56. The passage 56, the retention member(s) 62, and the arm(s) 58 are configured to provide a snap-fit coupling between the ferrule holder 46 and housing 50. As will be described in greater detail below, the arm(s) 58 of the ferrule holder 46 are flexed toward the body 48 when the ferrule holder 46 is moved in the passage 56 from the front end 60 of the housing 50 to the assembled position, at which point the arm(s) 58 move back away from the body 48 to cooperate with the retention member(s) 62.

It is to be noted that the general principles described above with reference to FIG. 2 may be applicable to embodiments other than the one shown. Thus, although details of the particular embodiment shown will now be described, these details may not necessarily be part of other embodiments to which the general principles apply.

With this in mind, FIG. 3 is an enlarged view of the ferrule holder 46, FIG. 4 is a cross-sectional view of the fiber optic connector 40 in an assembled condition, and FIG. 4A is an enlarged view of the area circled in FIG. 4A. The body 48 of the ferrule holder 46 includes a first end portion 70 in which the ferrule 42 is received. More specifically, the first end portion 70 defines a first bore 72 to which the ferrule 42 is secured. The ferrule 42 may be press-fit into the first bore 72, for example. Alternatively, and as shown, the ferrule holder 46 may be overmolded onto an end portion of the ferrule 42. Overmolding helps reduce or eliminate the risk of the ferrule 42 falling out of the ferrule holder 46. Regardless of how the ferrule 42 is secured, the body 48 further includes one or more additional bores 74 communicating with the first bore 72 so that a passage extends through the body 48. The additional bores 74 may be defined by a second end portion 76 of the ferrule holder 46 opposite the first end portion 70.

In the embodiment shown in FIGS. 2-4A, the second end portion 76 of the body 48 is generally conical and/or cylindrical and includes first and second sections 76a, 76b (FIG. 3) having different outer diameters. Thus, a step or shoulder 80 is defined between the first and second sections 76a, 76b. Either or both of the first and second sections 76a, 76b may include a ramped outer surface 82 so as to have a tapered profile and thereby provide a conical configuration. The first end portion 70 of the body 48 may likewise be generally cylindrical and/or conical, but with truncated outer surfaces 84 at diametrically-opposed locations. The truncated outer surfaces 84 are generally planar and confront the arms 58, which extend over the truncated outer surfaces 84.

To this end, the first and second arms 58a, 58b of the ferrule holder 46 extend from diametrically opposed locations on the second portion 76 of the body 48. The arms 58 extend in an axially forward direction (i.e., axially toward the first end portion 70 of body 46) and over portions of the truncated outer surfaces 84 such that respective spaces 86 are defined between the arms 58 and truncated outer surfaces 84, at least when the arms 58 are in an unflexed condition. Each arm 58 includes a proximal end 88 coupled to the body 48, a distal end 90 offset from the body 48, and an intermediate portion 92 extending between the proximal and distal ends 88, 90. At the proximal ends 88, the arms 58 may extend radially outward from the body 48 so as to define a step or shoulder 94. The distal ends 90 extend even further radially outward such that, in general, the arms 58 extend at an angle relative to the longitudinal axis 44. In other words, in an addition to extending in an axially forward direction, the arms 58 can be considered to extend in a radially outward direction. The intermediate portion 92 may define at least one ramped outer surface 96 between the proximal and distal ends 88, 90 to provide such a configuration.

Still referring to FIGS. 2-4A, the passage 56 of the housing 50 is generally cylindrical but may include one or more keys 100 each shaped to receive one of the arms 58 of the ferrule holder 46. Each key 100 extends from the front end 60 of the housing 50 to one of the retention members 62. When the keys 100 are grooves formed in an inner surface of the housing 50, the grooves may vary in depth relative to the inner surface between the front end 60 and retention members 62. For example, as shown in FIG. 4, the keys 100 may decrease in depth as they extend from the front end 60 to the retention members 62. Such configuration provides the portion of the passage 56 which includes the keys 100 with a tapered profile. The keys 100 may also extend slightly beyond the retention members 62 so that walls 102 (FIG. 4A) defining front ends of the keys 100 are located behind (i.e., axially rearward from) the retention members 62.

At a rear end 110 of the housing 50, the crimp body 54 extends in a rearward direction. The housing 50 is shown as being molded over the crimp body 54, which may be machined from metal or molded from another material. However, other ways of coupling the crimp body 54 to the rear end 110 of the housing 50 are possible. Additionally, in some embodiments, the crimp body 54 may be integrally formed with the housing 50. That is, the housing 50 and crimp body 54 may be molded as a single, unitary component. This has the advantage of reducing the number of components in the overall assembly, which may reduce costs and facilitate the assembly process (e.g., reduce the number of assembly steps). The crimp body 54 in any of the above-mentioned embodiments may include at least one section having a reduced cross-sectional width relative to the housing 50 (or remainder of the housing for integrally molded embodiments). As a result, the crimp body 54 more closely surrounds a lead-in tube 112 that receives and guides the optical fiber to the ferrule holder 46 from the rear end of the fiber optic connector 40. Such an arrangement allows for a more secure connection between the optical fiber and fiber optic cable when the crimp body 54 is crimped or otherwise deformed onto the cable to complete the connection.

Within the housing 50, the spring 52 is disposed between the ferrule holder 46 and the crimp body 54. One end of the spring 52 abuts a bias member mounting portion 116, which is a stepped surface defined by the crimp body 54 in this embodiment, while another end of the spring 52 abuts the shoulder 80 on the body 48 of the ferrule holder 46. Thus, a portion of the spring 52 surrounds the second end portion 76 of the body 48. In alternative embodiments, the bias member mounting portion 116 may be defined by a portion of the housing 50 instead of the crimp body 54.

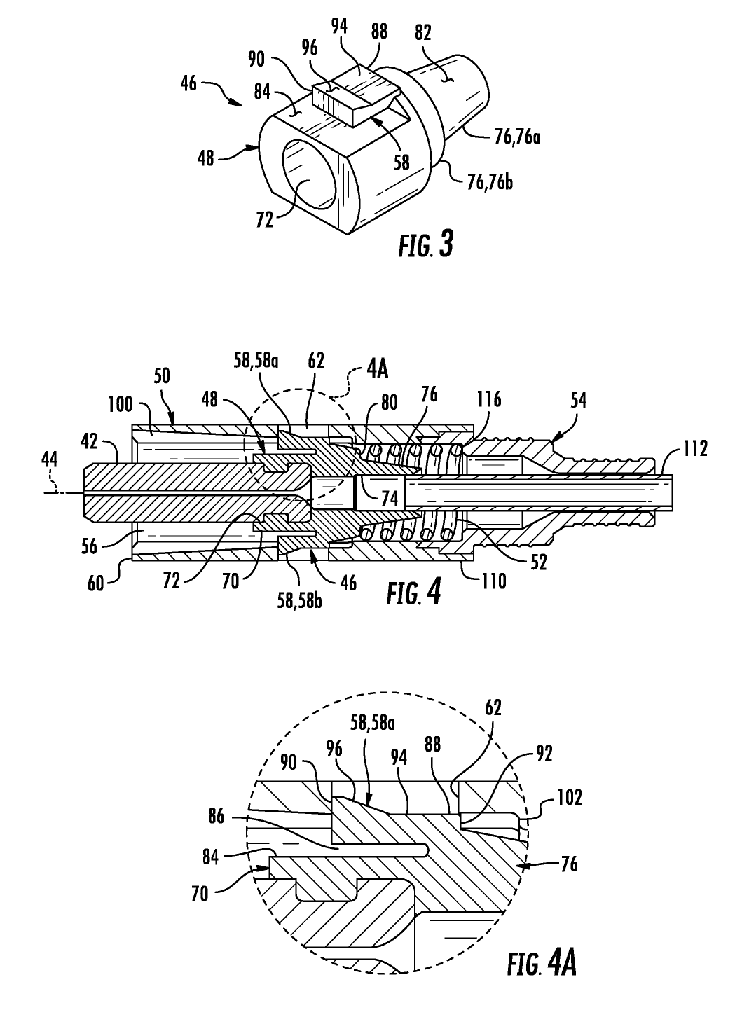

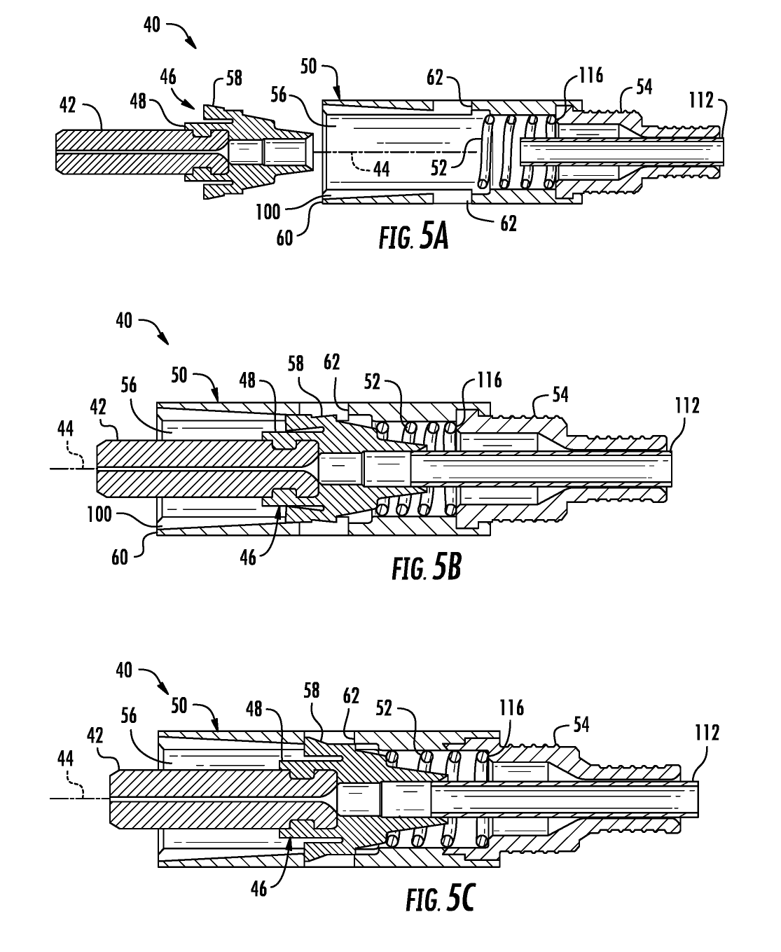

The assembly of the fiber optic connector 40 will now be described with reference to FIGS. 5A-5C. The housing 50 and crimp body 54 are provided as discussed above, with the lead-in tube 112 extending through the crimp body 54 and into the passage 56 of the housing 50. The spring 52 is then inserted into the passage 56 from the front end 60 of the housing 50 until the spring 52 abuts the bias member mounting portion 116. At this point, the housing 50 is ready to receive the ferrule holder 46 and ferrule 42 (FIG. 5A). A user then aligns the arms 58 of the ferrule holder 46 with the keys 100 of the passage 56 and inserts the ferrule holder 46.

The keys 100 cooperate with the arms 58 to constrain relative rotation between the ferrule holder 46 and housing 50 as the ferrule holder 46 is moved along the passage 56. As a result, the keys 100 guide the arms 58 toward the retention members 62. At some point before reaching the retention members 62, the arms 58 contact the inner wall of the housing 50. This contact may occur upon initial insertion (i.e., at the front end 60 of the housing 50) or after initial insertion (i.e., somewhere between the front end 60 and retention members 62). Regardless, and as shown in FIG. 5B, the contact causes the arms 58 of the ferrule holder 46 to flex toward the body 48 as the ferrule holder 46 is moved further along the passage 56 toward the retention members 62. Providing the passage 56 with a tapered profile has the advantage of making this flexing gradual such that the contact does not significantly impeded or otherwise interfere with continued insertion of the ferrule holder 46.

Eventually the arms 58 of the ferrule holder 46 reach the retention members 62, as shown in FIG. 5C, at which point the arms 58 move back away from the body 48. To facilitate this movement, the keys 100 in the passage 56 of the housing 50 may extend slightly past the retention members 62. As a result, the ferrule holder 46 may be moved along the passage 56 until the step or shoulder 92 (FIG. 4A) at the proximal end 88 of each arm 58 contacts the front wall 102 of the key 100 in which the arm 58 is positioned. In this regard, the keys 100 effectively define an “overshoot portion” between the retention members 62 and front walls 102, and the front walls 102 effectively define a “hard stop” that prevents further insertion of the ferrule holder 46 along the passage 56. The distal ends 90 of the arms 58 can move away from the body 48 (i.e., flex back outwardly) even when the proximal ends 88 of the arms 58 are received in the overshoot portion. Thus, such an arrangement provides an opportunity for the arms 58 to move back away from the body 48 over an increased distance. However, embodiments will be appreciated where the keys 100 do not define any overshoot portion.

Now referring collectively to FIGS. 5A-5C, it can be seen how the spring 52 is compressed as the ferrule holder 46 is inserted into the passage 56 and moved toward the retention members 62. This results in the spring 52 applying a biasing force to the ferrule holder 46 in a direction toward the front end 60 of the housing 50. Upon releasing the ferrule holder 46, a biasing force applied by the spring 52 urges the ferrule holder 46 back towards the front end 60 of the housing 50. Contact between the distal ends 90 of the arms 58 and the retention members 62 limits this movement.

As can be appreciated, and as mentioned above, the arrangement of the passage 56, arms 58, and retention members 62 provides a snap-fit coupling or connection between the ferrule holder 46 and housing 50. The retention members 62 in the embodiment shown are openings formed between the outer surface 64 of the housing 50 and the passage 56, but the retention members 62 may alternatively be notches, latches, or some other structure configured to engage or otherwise cooperate with the arms 58 to provide the snap-fit coupling.

Additionally, although the retention members 62 in the embodiment shown accommodate the arms 58 in an unflexed condition, in alternative embodiments the retention members 62 may be configured such that arms 58 still retain some degree of bias/flexing when coupled to the housing 50. The general principle that will be appreciated by skilled persons is that a constricting portion of the passage 56 between the front end 60 of the housing 50 and the retention member(s) 62 is sized to limit the arm(s) 58 of the ferrule holder 46 to a first radial position relative to the body 48, while a retention portion of the housing 50 is configured to accommodate the ferrule holder 46 with the arm(s) 58 in a second radial position relative to the body 48. The second radial position is further from the longitudinal axis 44 than the first radial position, but need not be so far as to represent an unflexed condition of the arms. The retention portion of the housing 50 may comprise, for example (and in a manner not shown herein) recesses, grooves, notches, wells, or the like in the interior wall of the housing 50 that to some extent still limit movement of the arms 58 to an unflexed position.

The snap-fit design has the advantage of making the fiber optic connector 40 easy to assemble. The assembly process can be completed with a simple movement of the ferrule holder 46 along the longitudinal axis 44; no rotation within the housing 50 is required. This may allow for simpler machines and fixtures when the assembly process is automated. Moreover, the components of the fiber optic connector 40 themselves remain easy to manufacture, for example, by not requiring complex molding operations or equipment. Another advantage provided by the snap-fit design is that the housing 50 has a relatively high degree of structural stiffness and stability. The arms 58 of the ferrule holder 46 are the component that flexes in the snap-fit coupling rather the housing 50. The housing 50 can therefore be made relatively rigid, with the retention members 62 being sized and positioned such that the housing 50 is able to withstand loads without significantly deflecting or otherwise affecting the positioning and performance of the ferrule holder 46 and ferrule 42.

FIG. 6 illustrates a fiber optic connector 120 according to an alternative embodiment that incorporates some of the alternative design possibilities mentioned above. In particular, in the embodiment shown in FIG. 5, the crimp body 54 is integrally formed with the housing 50. Providing the crimp body 54 and housing 50 as a single, unitary component may allow for even further reductions in parts, assembly steps, complexities, and cost. FIG. 5 also illustrates how the ferrule 42 may be press-fit into the first bore 72 of the ferrule holder 46 instead of being overmolded by the ferrule holder 46.

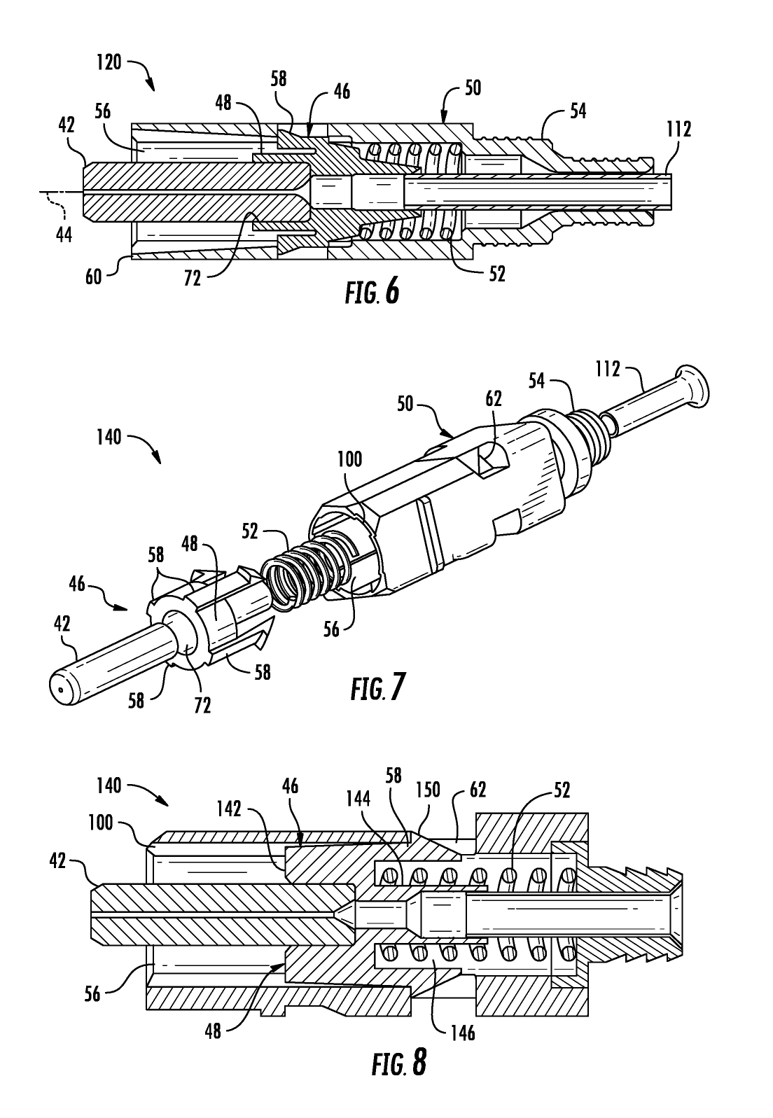

Other design variations can be seen in FIGS. 7 and 8, which illustrate a fiber optic connector 140 according to yet another alternative embodiment. In FIGS. 7 and 8, the fiber optic connector 140 includes a ferrule holder 46 with four arms 58 circumferentially distributed about the body 48 of the ferrule holder 46. Additionally, the arms 58 extend from a first portion 142 of the body 48 in an axially rearward direction (i.e., axially toward a second end portion 144 of the body 48). The second end portion 144 has a reduced diameter compared to the first end portion 142 such that a space 146 is defined between the arms 58 and an outer surface of the second end portion 144. The spring 52 is disposed within the space 146 when the fiber optic connector 140 is assembled.

The assembly of the fiber optic connector 140 is similar to that described above for the fiber optic connector 40. As shown in FIGS. 7 and 8, the housing 50 includes a passage 56 with four keys 100 and four retention members 62. The keys 100 guide the arms 58 of the ferrule holder 46 to the retention members 62 as the ferrule holder 46 is inserted into and moved along the passage 56 from the front end 60 of the housing 50. Upon initial insertion or sometime thereafter, the arms 58 contact the inner wall of the housing 50 and flex toward the body 48. Each arm 58 may include a ramped outer surface 150 to facilitate insertion of the ferrule holder 46 into the housing 50 and flexing of the arms 58 toward the body 48 of the ferrule holder 46. Upon reaching the retention members 62, the arms 58 are able to move back away from the body 48 so as to be received in or otherwise cooperate with the retention members 62. Engagement and/or contact between the arms 58 and the retention members 62 prevent the ferrule holder 46 from being withdrawn from the housing 50. Further details of the fiber optic connector 140 and its assembly need not be described because the general principles and possibilities discussed above in connection with the fiber optic connector 40 remain applicable. Accordingly, reference can be made to the description above for a more complete understanding.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A fiber optic connector inner housing sub-assembly for mounting and retaining a ferrule holder as part of a fiber optic connector sub-assembly, comprising:
an inner housing having an opening extending therethrough, wherein the opening comprises a front end, a rear end, and an interior surface; and
at least one bayonet locking mechanism comprising:
an insertion slot disposed in the interior surface of the opening and configured to receive a respective key portion of a ferrule holder when the ferrule holder is inserted into the front end of the opening;
a rotation slot disposed in the interior surface of the opening for rotating the key portion of the ferrule holder away from the insertion slot; and
a retention slot disposed in the interior surface of the opening for retaining the ferrule holder in the inner housing.

2. The fiber optic connector inner housing sub-assembly of claim 1, wherein the inner housing comprises a stop disposed at a front end of the retention slot to provide a stop surface for retaining the ferrule holder in the inner housing.

3. The fiber optic connector inner housing sub-assembly of claim 1, wherein the insertion slot is a groove extending substantially parallel to a longitudinal axis of the fiber optic connector inner housing.

4. The fiber optic connector inner housing sub-assembly of claim 3, wherein one of a portion of the rotation slot and a portion of the retention slot extends from the interior surface of the opening through an outer surface of the fiber optic connector inner housing.

5. The fiber optic connector inner housing sub-assembly of claim 1, wherein the retention slot extends substantially parallel to a longitudinal axis of the fiber optic connector inner housing.

6. The fiber optic connector inner housing sub-assembly of claim 1, wherein the rotation slot extends substantially perpendicular to a longitudinal axis of the fiber optic connector inner housing.

7. The fiber optic connector inner housing sub-assembly of claim 1, wherein the rotation slot includes a ramp surface configured to cause the key portion of the ferrule holder to rotate away from the insertion slot with respect to a longitudinal axis of the fiber optic connector inner housing when an insertion force parallel to the longitudinal axis is applied to the ferrule holder.

8. The fiber optic connector inner housing sub-assembly of claim 7, wherein the rotation slot includes a second ramp surface configured to cause the key portion of the ferrule holder to rotate the key portion toward the retention slot when a bias force parallel to the longitudinal axis in a direction opposite the direction of the insertion force is applied to the ferrule holder.

9. The fiber optic connector inner housing sub-assembly of claim 1, wherein the rotation slot includes a ramp surface configured to cause the key portion of the ferrule holder to rotate the key portion toward the retention slot with respect to a longitudinal axis of the inner housing toward the retention slot when a bias force parallel to the longitudinal axis is applied to the ferrule holder.

10. The fiber optic connector inner housing sub-assembly of claim 1, further comprising a latch configured to permit movement of the key portion of the ferrule holder from the rotation slot into the retention slot, and to impede movement of the key portion of the ferrule holder from the retention slot into the rotation slot.

11. The fiber optic connector inner housing sub-assembly of claim 10, wheren the latch includes first and second substantially straight sections separated by a bend.

12. The fiber optic connector inner housing sub-assembly of claim 10, wheren the latch comprises a leaf-spring.

13. The fiber optic connector inner housing sub-assembly of claim 1, further comprising a crimp body connected to the inner housing at the rear end of the opening, wherein the inner housing is integarlly formed with a crimp body at the rear end of the opening.

14. A fiber optic connector sub-assembly comprising:
an inner housing sub-assembly comprising:
an inner housing having an opening extending therethrough, wherein the opening comprises a front end, a rear end, and an interior surface;
at least one bayonet locking mechanism comprising:
an insertion slot disposed in the interior surface of the opening;
a rotation slot disposed in the interior surface of the opening; and
a retention slot disposed in the interior surface of the opening; and
a bias member mounting portion disposed at the rear end of the opening;
a ferrule holder disposed in the inner housing and having a key portion, the front end of the opening being configured to accommodate the ferrule holder; and
a bias member disposed in the inner housing between the ferrule holder and the bias member mounting portion;
wherein the insertion slot is configured to receive the key portion of the ferrule holder when the ferrule holder is inserted into the opening;
wherein the rotation slot is configured to allow the ferrule holder to be rotated away from the insertion slot; and
wherein the bias member is configured to move the key portion of the ferrule holder into the retention slot when the ferrule holder is released, thereby retaining the ferrule holder in the inner housing.

15. The fiber optic connector sub-assembly of claim 14, further comprising a crimp body connected to the inner housing at the rear end of the opening, wherein the inner housing is integrally formed with a crimp body at the rear end of the opening.

16. The fiber optic connector sub-assembly of claim 14, further comprising a shroud mounted to the fiber optic connector inner housing.

17. The fiber optic connector sub-assembly of claim 14, further comprising an optical fiber extending through a rear end of the ferrule holder and connected to a fiber optic ferrule mounted in the ferrule holder.

18. The fiber optic connector sub-assembly of claim 14, wherein the key portion of the ferrule holder is a protrusion such that the insertion slot, rotation slot and retention slot of the inner housing are configured to slidably accommodate the protrusion.

19. A method of assembling a fiber optic connector sub-assembly comprising:
providing an inner housing sub-assembly comprising:
an inner housing having an opening extending therethrough, wherein the opening comprises a front end, a rear end, and an interior surface;
at least one bayonet locking mechanism comprising:
an insertion slot disposed in the interior surface of the opening;
a rotation slot disposed in the interior surface of the opening; and
a retention slot disposed in the interior surface of the opening; and
a bias member mounting portion disposed at the rear end of the opening;
providing a bias member in the inner housing adjacent the bias member mounting portion;
inserting the ferrule holder into the front end of the opening of the inner housing such that the key portion is received by the insertion slot and the bias member is disposed between the ferrule holder and the bias member mounting portion;
rotating the ferrule holder about a longitudinal axis of the opening such that the key portion rotates within the rotation slot; and
releasing the ferrule holder such that the bias member moves the key portion of the ferrule holder into the retention slot, thereby retaining the ferrule holder in the inner housing.

20. The method of claim 19, wherein:
inserting the ferrule holder into the front end of the opening comprises applying an insertion force to the ferrule holder in a first direction substantially parallel to the longitudinal axis of the inner housing; and
rotating the ferrule holder about the longitudinal axis comprises continuing to apply the insertion force in the first direction.
